(19) United States
(12) Patent Application Publication
(10) Pub. No.: US 2016/0030964 A1
(43) Pub. Date: Feb. 4, 2016

(54) Painting Cover

(71) Applicants: Andrew Mikesell, SR., Indianapolis, IN (US); Michele Mikesell, Indianapolis, IN (US)

(72) Inventors: Andrew Mikesell, SR., Indianapolis, IN (US); Michele Mikesell, Indianapolis, IN (US)

(21) Appl. No.: 14/170,457

(22) Filed: Jan. 31, 2014

Related U.S. Application Data
(60) Provisional application No. 61/759,624, filed on Feb. 1, 2013.

(51) Int. Cl. B05B 15/04

(52) U.S. Cl. CPC B05B 15/045

(57) ABSTRACT

A flexible cover for use in quickly and safely covering electrical outlets, switches and other openings is provided. The cover serves to protect the materials behind it while the surrounding surface is painted or the like. The cover includes a set of tabs which provide for a friction fit within the opening. The cover may be of a number of different shapes and sizes, such as that of a single or double gang outlet box.

### CROSS-REFERENCE TO RELATED APPLICATIONS

The benefit of U.S. Provisional Patent Application No. 61/759,624 (filed Feb. 1, 2013) is claimed, and that provisional application is hereby incorporated by reference.

### STATEMENT REGARDING FEDERAL SPONSORED RESEARCH OR DEVELOPMENT

Not Applicable.

### REFERENCE TO SEQUENCE LISTING, ETC.

Not Applicable.

### FIELD OF THE DISCLOSURE

The present disclosure relates to a flexible painting cover to be used by painters as a means to increase the speed in which they are able to complete a painting assignment by eliminating an element of the preparation work which is normally used. More specifically, the present disclosure relates to a flexible painting cover or insert that can quickly and easily be applied to switches, outlets and other openings which would traditionally need to be protected in another way.

Typically, in order to complete a “professional” looking painting job, the painter would seek to ensure that the paint was only put on those areas in which paint was meant to be applied. Historically, in order to address this issue a painter would painstakingly remove all switch covers, outlet covers, data covers, hanging light outlet covers, etc. They would then use “painter's tape” to tape over the switches, power outlets, data outlets, hanging lights, etc. However, this task is very time-consuming as well as expensive (once the worker's time plus the tape and other materials) is considered. The present invention introduces a flexible painting cover which can quickly and easily be applied to switches, power outlets, data outlets and the like, to protect them from inadvertent paint being applied to them. Once the painting project is completed the flexible painting cover can be removed and the switch covers, outlet covers, etc. can be replaced.

Likewise, in new construction, the flexible painting cover could even be applied to the outlet boxes as a way to minimize the possibility that drywall mud might be accidentally placed in the outlet boxes. This application can even be done prior to the time electrical work is completed, in that the present invention does not require an outlet or switch be present for the cover to be held in place.

### BRIEF DESCRIPTION OF THE DRAWINGS

FIG. 1, shows one version of the flexible painting cover including a top, front and side view.

FIG. 2 is a three-dimensional view of the flexible painting cover.

FIG. 3 shows a flattened view of the flexible painting cover.

FIG. 4 shows a flexible painting cover as applied to a power outlet in front and side view.

### DESCRIPTION

For the purpose of promoting an understanding of the principles of the present invention, reference will now be made to the embodiment illustrated in specific language contained herein. It will, nevertheless, be understood that no limitation of the scope of the invention is thereby intended; any alterations and further modifications of the described or illustrated embodiments and any further applications of the principles of the invention as illustrated therein are contemplated as would normally occur to one skilled in the art to which the invention relates.

One embodiment of this invention could be a flexible painting cover made of plastic or similar material in which paint does not easily adhere and/or in which paint can be easily removed without damaging the material. In this way the cover could be disposable or used again many times. Additionally, the thickness of the material will be relatively small to support flexibility, kept it lightweight and ensure ease of handling. The size of the cover would be such that it would approximately the size of a single electrical switch or outlet box, understanding that the size could be increased to accommodate double, triple or more, electric switch boxes, as necessary, as well as circular electrical boxes normally seen with wall or ceiling mounted lights.

In one version of the present invention, at the top and bottom of the cover would be two tabs which extend past the size of the cover and in a flattened view would extend up and down for approximately one and one-half inches. These tabs would be of such a width that they could easily be inserted into a switch outlet or power outlet without the necessity of removing the switch or outlet from the switch box or outlet box. Additionally, these tabs would be of such shape and size to allow for someone to insert them into the switch or outlet box using only a single hand.

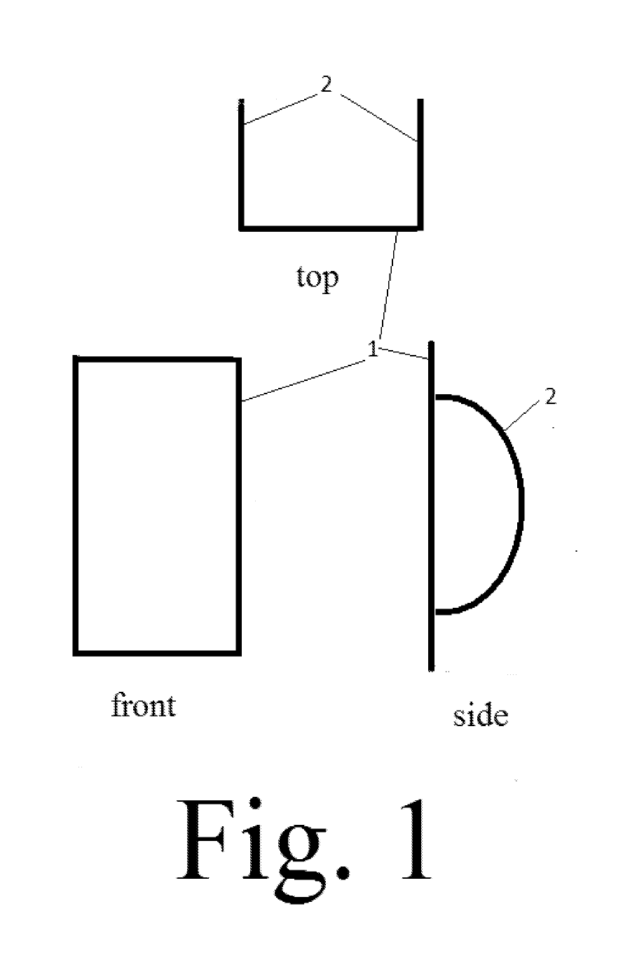

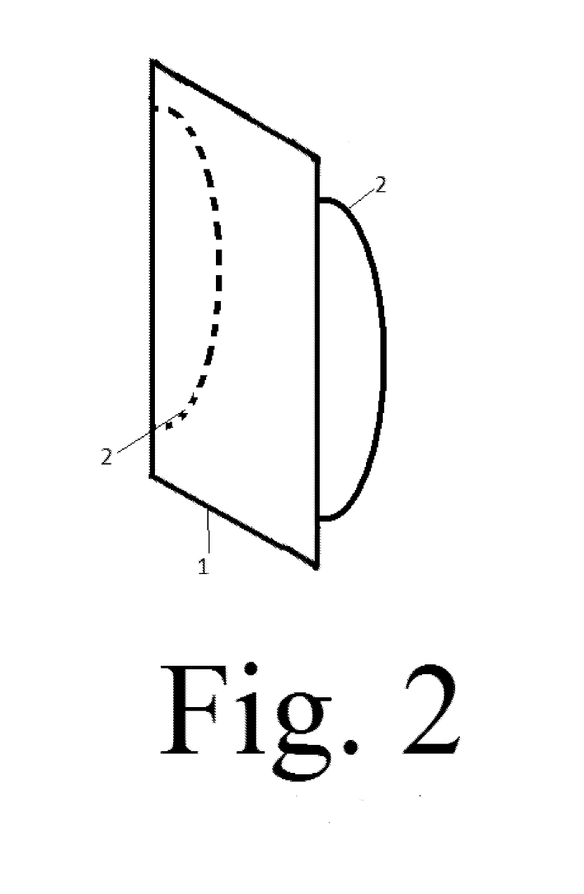

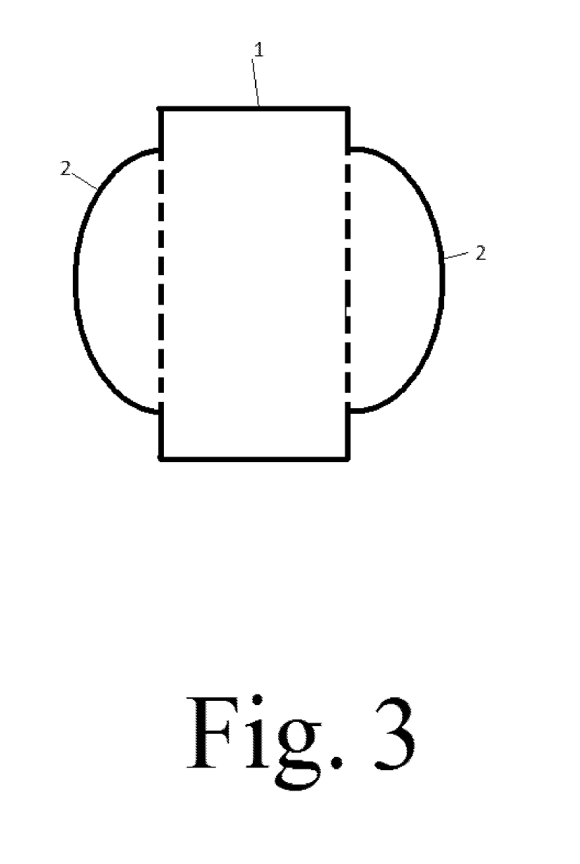

In the preferred embodiment as seen in FIG. 1, the cover, 1, would be of rectangular shape, when viewed from the front and have tabs, 2, which protrude back along the sides of the cover. In this embodiment, the size of the tabs would be approximately 2 inches from top to bottom and extend back for 1 and ½ inches. The tab would be centered between the top and bottom of the cover. The tabs would also be of a curved shape to reduce the possibility that the tabs could get caught on something as they are being inserted. This design is also seen in FIGS. 2 and 3.

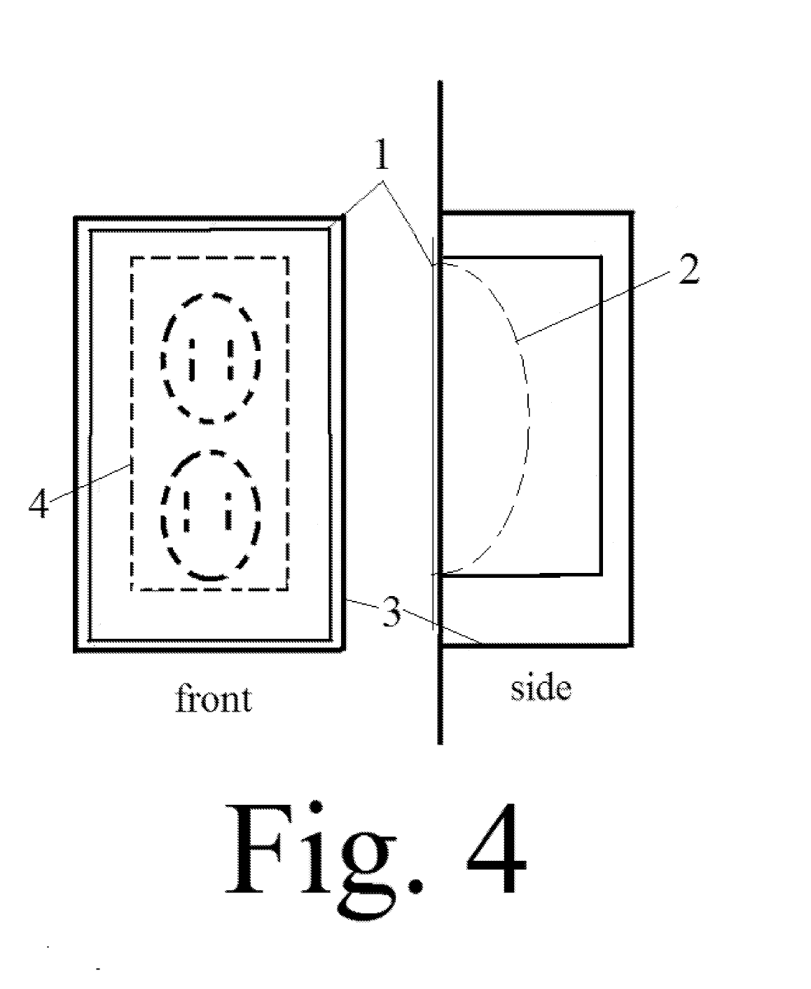

As has been noted, due to the flexible nature of the material used, which can be of any material that maintains flexibility over multiple uses and repeals paint adhesion, the tabs have a tendency to resist being pushed to 90 degrees from the face of the cover. Therefore, as the tabs are bent toward the switch or outlet box, prior to insertion, upon release of the tabs, they would provide a frictional fit with the switch or outlet box such that they would remain in place while painting took place. This is seen in FIG. 4, as the cover, 1, is held in place by the outward push of the tabs against the side of the outlet box, 3. The insertion means noted also encourages safety in that the hands of workers do not go near the power outlet itself, 4, or the set screws associated with them or those of a switch, which can help avoid workers being shocked or otherwise injured. Further, the flexibility of this embodiment would allow for application of the cover over a switch, which normally protrudes slightly from the plane of the wall in which they are installed. Another variation of this element could include a bump-out on the otherwise flat surface, to allow for the fact that the switch or knob would fit, so that the main element of the cover would remain flush with the wall. Once the painting assignment is completed, the flexible painting covers can be easily removed by pulling them out either by grabbing the center of the cover or the top or bottom. Since the frictional fit will not be overly tight, removal will be easy and, once again, safety encouraged, as the workers fingers will not be near either the power outlet itself or the set-screws for the switch.

Another embodiment of the present invention would encompass only two tabs, either on the bottom and top or transversely one on top and other on the opposite side bottom. A further embodiment might also include a bump-out which would allow for placement over a switch without the need of the cover to flex in the middle or otherwise be transformed. Any of the referenced embodiments could also features tabs which were shorter or longer than one and one-half inches. It is also possible for any embodiment to also include a material of heavier gauge to increase the durability of the cover such that it can be used over an extended period. Additionally, each embodiment could include a center tab which is located on the front of the cover and protrudes outward slightly, to provide for quick and easy insertion and removal of the cover.

A further embodiment could be a cover, which incorporates a means other than friction to hold it in place. This means could include hook and loop adhesive pads or tabs which might fit into the receptacles of a power outlet or providing a hole with which a switch might protrude and provide a means to attach to the switch, thus holding the cover in the place.

While the invention has been illustrated and described in detail with the foregoing description, the same is to be considered as illustrative and not restrictive in character, it being understood that only the preferred embodiment has been described and that all changes and modifications that come within the spirit of the invention are desired to be protected.

What is claimed is:

1) A Flexible Painting Cover comprising:
a) a cover made of a flexible material which repeals paint adhesion and has a generally rectangular shape;
b) two tabs connected to opposite sides of the cover and which protrude from the cover and can be bent back to approximately 90 degrees from the front of the cover;
c) said tabs being of such material that some small amount of force is required to bend them back to the approximately 90 degrees and such bending generates sufficient force that the cover is held in place when the cover and tabs are inserted into an electrical outlet box such that the cover is over the open side of the outlet box and the tabs are within the box and pushing out against two sides of the box.

2) The Flexible Painting Cover of claim 1 whereby the two tabs are on the left and right sides of the cover and are curved in shape.

3) The Flexible Painting Cover of claim 1 whereby the two tabs are on the top and bottom sides of the cover and are curved in shape.

4) The Flexible Painting Cover of claim 1 whereby the two tabs are on the left and right sides of the cover and are rectangular in shape.

5) The Flexible Painting Cover of claim 1 whereby the two tabs are on the top and bottom sides of the cover and are rectangular in shape.

6) The Flexible Painting Cover of claim 1 whereby the cover contains a bump-out to accommodate a light switch or other protrusion.

7) A Flexible Painting Cover comprising:
a) a cover made of a flexible material which repeals paint adhesion and has a generally rectangular shape;
b) two tabs connected to opposite sides of the cover and which protrude from the cover and can be bent back to approximately 90 degrees from the front of the cover;
c) said tabs being of such material that some small amount of force is required to bend them back to the approximately 90 degrees and such bending generates sufficient force that the cover is held in place when the cover and tabs are inserted into an electrical outlet box such that the cover is over the open side of the outlet box and the tabs are within the box and pushing out against two sides of the box;
d) with an element connected to the front of the cover, opposite the way the tabs bend, to allow for someone to grab and pull the cover, thus removing it from the outlet.

8) The Flexible Painting Cover of claim 7 whereby the two tabs are on the left and right sides of the cover and are curved in shape.

9) The Flexible Painting Cover of claim 7 whereby the two tabs are on the top and bottom sides of the cover and are curved in shape.

10) The Flexible Painting Cover of claim 7 whereby the two tabs are on the left and right sides of the cover and are rectangular in shape.

11) The Flexible Painting Cover of claim 7 whereby the two tabs are on the top and bottom sides of the cover and are rectangular in shape.

12) The Flexible Painting Cover of claim 7 whereby the cover contains a bump-out to accommodate a light switch or other protrusion.

13) A flexible painting cover comprising:
a) a cover made of a flexible material which repeals paint adhesion and has a generally rectangular shape;
b) more than two tabs connected at opposite sides of the cover and which protrude from the cover and can be bent back to approximately 90 degrees from the front of the cover;
c) said tabs being of such material that some small amount of force is required to bend them back to the approximately 90 degrees and such bending generates sufficient force that the cover is held in place when the cover and tabs are inserted into an electrical outlet box such that the cover is over the open side of the outlet box and the tabs are within the box and pushing out against two sides of the box.

14) The Flexible Painting Cover of claim 13 whereby the tabs are on the left and right sides of the cover and are curved in shape.

15) The Flexible Painting Cover of claim 13 whereby the tabs are on the top and bottom sides of the cover and are curved in shape.

16) The Flexible Painting Cover of claim 13 whereby the tabs are on the left and right as well as on the top and bottom sides of the cover and are curved in shape.

17) The Flexible Painting Cover of claim 13 whereby the tabs are on the left and right sides of the cover and are rectangular in shape.

18) The Flexible Painting Cover of claim 13 whereby the tabs are on the top and bottom sides of the cover and are rectangular in shape.

19) The Flexible Painting Cover of claim 13 whereby the tabs are on the left and right sides as well as the top and bottom sides of the cover and are rectangular in shape.

20) The Flexible Painting Cover of claim 13 whereby the cover contains a bump-out to accommodate a light switch or other protrusion.
